(19) United States
(12) Patent Application Publication
(10) Pub. No.: US 2003/0146321 A1
(43) Pub. Date: Aug. 7, 2003

(54) One-way clutch for a fishing spool

(76) Inventor: Liang-Jen Chang, Taichung Hsien (TW)

Correspondence Address: BRINKS HOFER GILSON & LIONE, NBC TOWER, Suite 3600, 455 N. Cityfront Plaza Drive, Chicago, IL, 60611-5599, US

(21) Appl. No.: 10/072,481

(22) Filed: Feb. 6, 2002

(51) Int. Cl. A01K 89/02

(52) U.S. Cl. 242/247; 192/45

(57) ABSTRACT

A one-way clutch for a fishing spool includes a hollow cylindrical mounting seat, an inner ring sleeved non-rotatably on a driving shaft, and a retainer sleeved on the inner ring. An outer ring is sleeved on the retainer, and is disposed within the seat. A cover is connected fixedly to the seat so as to confine the inner ring, the retainer, and the outer ring within the seat. A bearing is disposed between the cover and the shaft. Several rollers are retained on an annular wall of the retainer between the inner and outer rings. A push lever of the retainer is operable so as to rotate the annular wall between a braking position, where the shaft is permitted to rotate in a single direction, and a release position, where the shaft is permitted to rotate in two directions.

### BACKGROUND OF THE INVENTION

1. Field of the Invention

This invention relates to a fishing spool, and more particularly to a one-way clutch for a fishing spool, which is used to control unidirectional rotation of a driving shaft.

2. Description of the Related Art

Referring to FIGS. 1 and 2, a conventional fishing spool is shown to include a rod-connecting member 11 that is connected to a fishing rod (not shown), a driving shaft 12, a spool body 13, and a one-way clutch 20. The driving shaft 12 is journalled within the rod-connecting member 11, and is connected fixedly to the spool body 13. The one-way clutch 20 includes a mounting seat 21 that is bolted onto the rod-connecting member 11, a bearing 22 that is disposed around the driving shaft 12, and a driving unit consisting of eleven elements A, B, C, D, E, F, G, H, I, J, K. The driving unit is operable so as to move between a braking position, where the driving shaft 12 can rotate in a single direction so as to prevent unwinding of a fishline, and a release position, where the driving shaft 12 can rotate in two directions so as to permit winding and unwinding of the fishline. The one-way clutch 20 consists of numerous elements, thereby resulting in a complex structure and increased manufacturing costs.

### SUMMARY OF THE INVENTION

The object of this invention is to provide a one-way clutch for a fishing spool, which is simple in construction.

According to this invention, a one-way clutch for a fishing spool includes a hollow cylindrical mounting seat, an inner ring sleeved non-rotatably on a driving shaft, and a retainer sleeved on the inner ring. An outer ring is sleeved on the retainer, and is disposed within the mounting seat. A cover is connected fixedly to an end of the mounting seat so as to confine the inner ring, the retainer, and the outer ring within the mounting seat. A bearing is disposed between the cover and the driving shaft. A plurality of rollers are retained on an annular wall of the retainer between the inner and outer rings. A push lever of the retainer is operable so as to rotate the annular wall between a braking position, where the driving shaft is permitted to rotate in a single direction, and a release position, where the driving shaft is permitted to rotate in two directions.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a fragmentary exploded perspective view showing a one-way clutch of a conventional fishing spool;

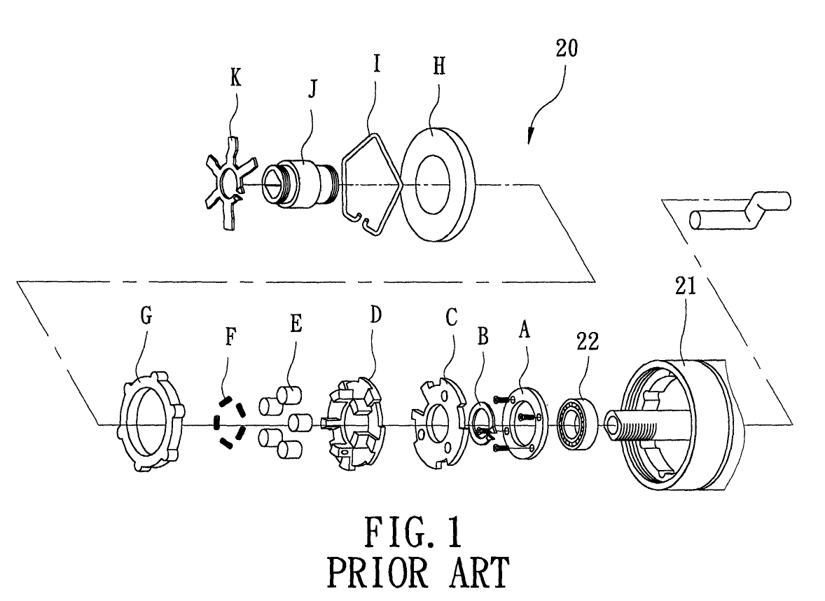

FIG. 2 is a sectional view of the conventional fishing spool, illustrating arrangement of the one-way clutch relative to a driving shaft and a spool body;

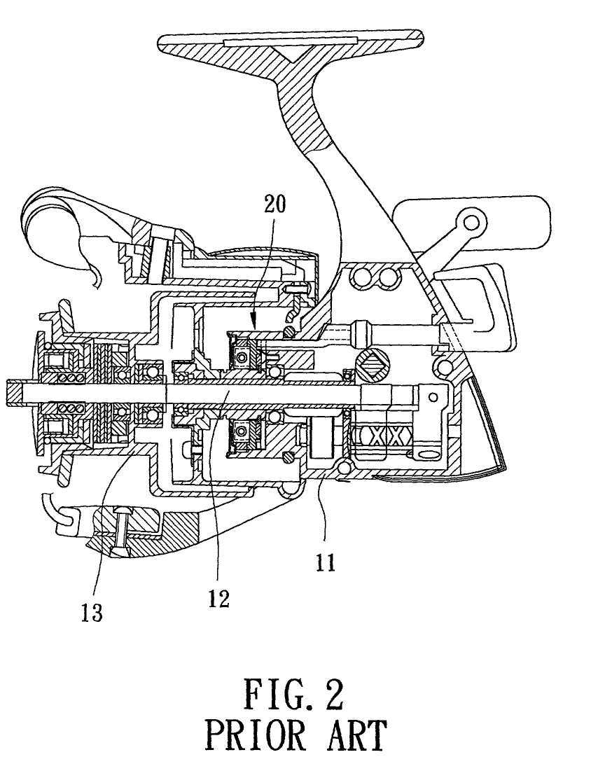

FIG. 3 is a fragmentary, partly exploded perspective view of a fishing spool incorporating the preferred embodiment of a one-way clutch according to this invention;

FIG. 4 is an exploded perspective view of the preferred embodiment;

FIG. 5 is a top view of an outer ring of the preferred embodiment;

FIG. 6 is a bottom view of a mounting seat, a retainer, and two return springs of the preferred embodiment;

FIG. 7 is a sectional side view of the preferred embodiment;

FIG. 8 is a schematic top view of the preferred embodiment, illustrating how an annular wall of the retainer is disposed at a braking position; and

FIG. 9 is a schematic top view of the preferred embodiment, illustrating how the annular wall of the retainer is disposed at a release position.

### DETAILED DESCRIPTION OF THE PREFRRED EMBODIMENT

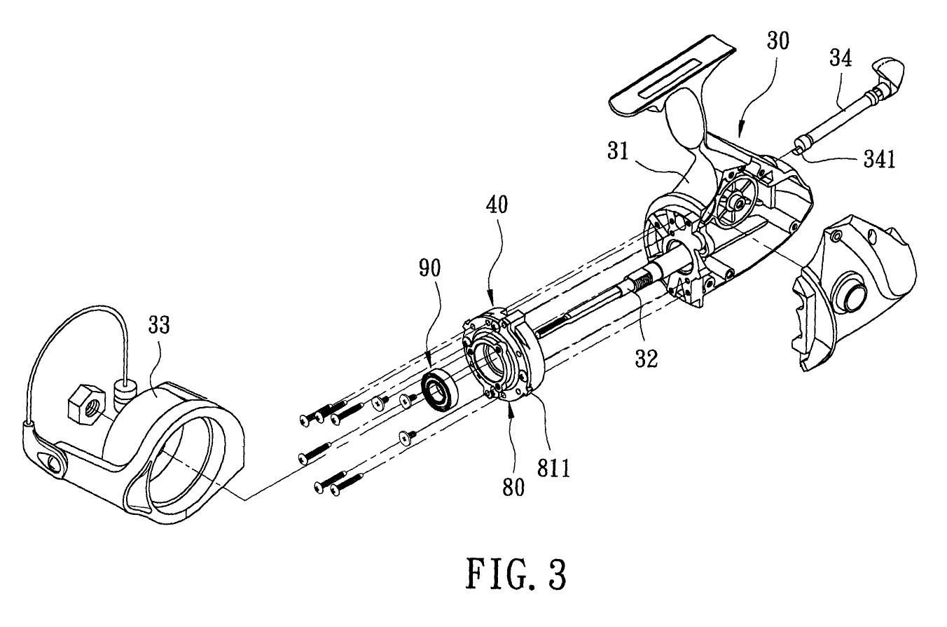

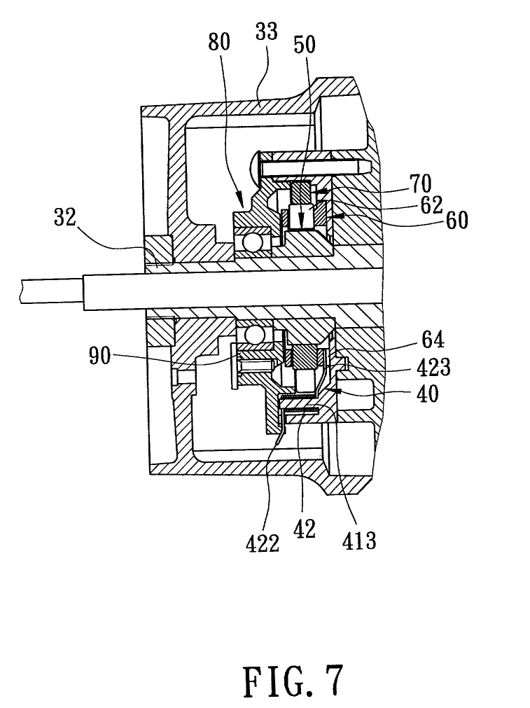

Referring to FIGS. 3, 4, 7, and 8, the preferred embodiment of a one-way clutch according to this invention is to be incorporated in a fishing spool 30, and is shown to include a hollow cylindrical mounting seat 40, an inner ring 50, a tubular retainer 60, an outer ring 70, a cover 80, and a bearing 90.

The fishing spool 30 includes a rod-connecting member 31 that is connected fixedly to a fishing rod (not shown), a driving shaft 32 that is journalled on the rod-connecting member 31, and a control rod 34 that is journalled on the rod-connecting member 31 and that is parallel to the driving shaft 32.

The mounting seat 40 is bolted onto the rod-connecting member 31, and is disposed around the driving shaft 32.

The inner ring 50 is sleeved non-rotatably on the driving shaft 32 in a known manner so as to rotate synchronously therewith.

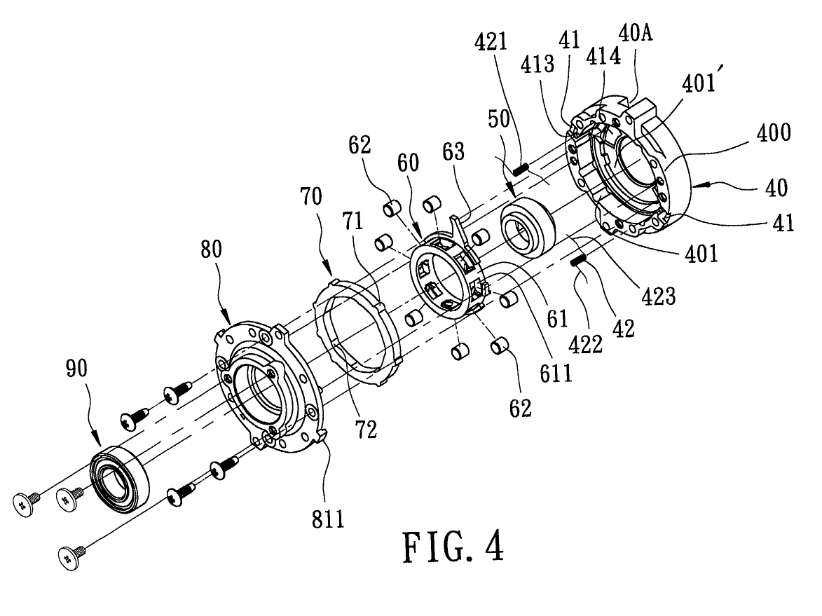

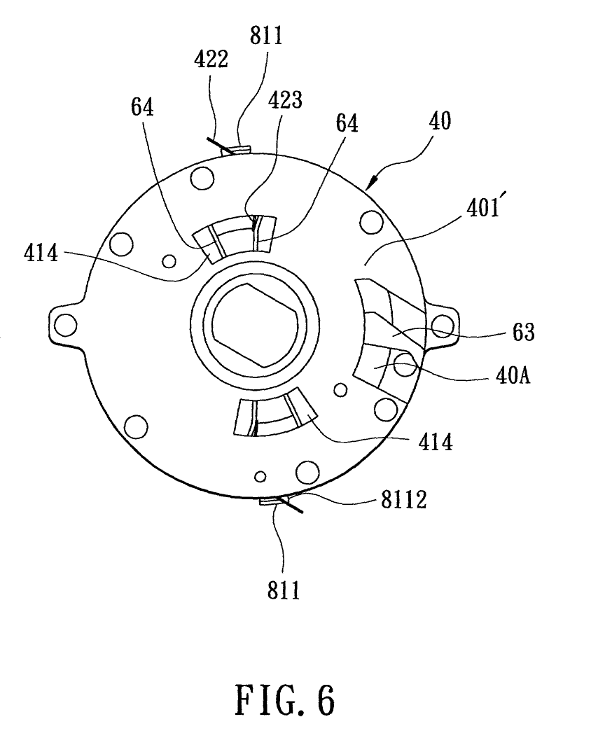

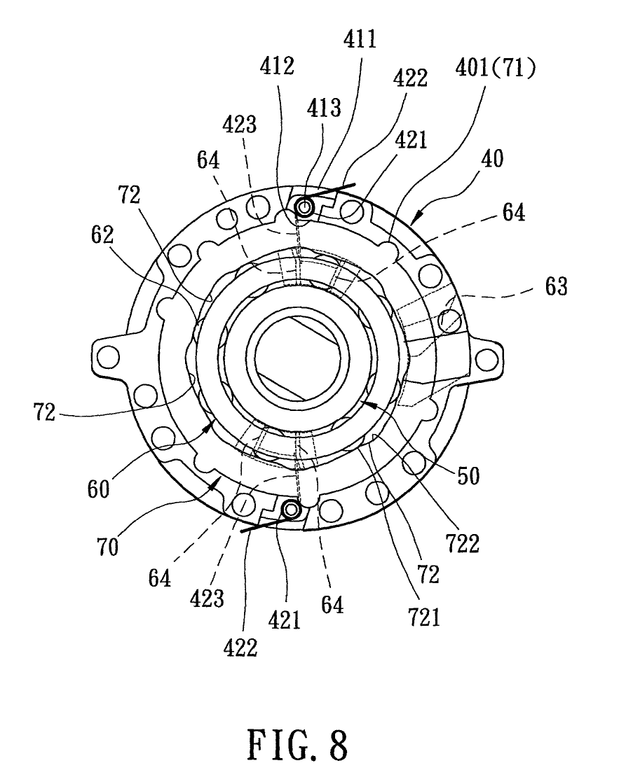

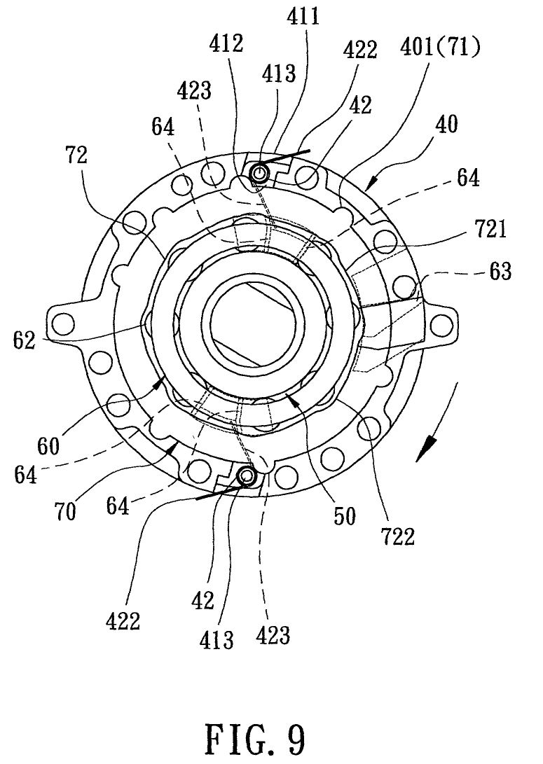

The retainer 60 includes an annular wall 61, which is formed with a plurality of roller-confining spaces 611 that are arranged along a circumferential direction of the annular wall 61 and that confine respectively a plurality of rollers 62 therewithin. Each of the roller-confining spaces 611 is shaped as an opening that is formed through the annular wall 61. The annular wall 61 is sleeved on the inner ring 50. A push lever 63 extends integrally, radially, and outwardly from an end of the annular wall 61, and projects outward through an opening (40A) (see FIGS. 4 and 6) in the mounting seat 40 so as to abut against an eccentric pin 342 on an end surface of the control rod 34. When the control rod 34 rotates, the pin 342 rotates the annular wall 61 between a braking position shown in FIG. 8, and a release position shown in FIG. 9.

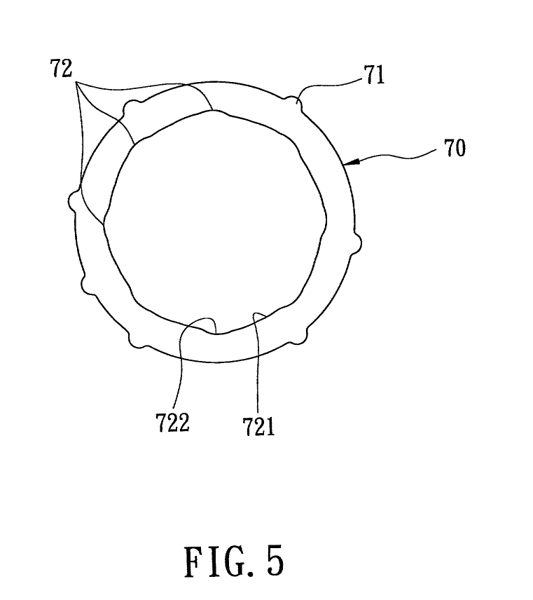

The outer ring 70 is sleeved on the annular wall 61 of the retainer 60, and has an outer surface 71, which is formed with a plurality of spaced-apart axial ribs 72 that engage respectively a plurality of axial slots 401 in an inner surface of a surrounding wall 400 of the mounting seat 40 so as to prevent rotation of the outer ring 70 within the mounting seat 40. An inner surface of the outer ring 70 is formed with a plurality of grooves 72 in a known manner, which are arranged along a circumferential direction of the outer ring 70. Each of the grooves 72 has a shallow groove portion 721 and a deep groove portion 722, as shown in FIG. 5.

The cover 80 is bolted onto an end of the mounting seat 40, and is disposed around the driving shaft 32 so as to confine the inner ring 50, the retainer 60, the outer ring 70, and the rollers 62 within the mounting seat 40.

The bearing 90 is disposed between the cover 80 and the driving shaft 32 so as to permit rotation of the driving shaft 32 relative to the cover 90. In this embodiment, the bearing 90 is located adjacent to the center of gravity of the fishing spool to improve the balance of the fishing spool.

Two biasing units are disposed at two diametrically opposed positions of the one-way clutch so as to bias the annular wall 61 of the retainer 6 to the braking position. Each of the biasing units includes a radial notch unit 41 in the mounting seat 40, two radially extending limiting ribs 64 on the retainer 60, an L-shaped tongue 811 on the cover 80, and a torsion spring 42. It should be noted that only one of the biasing units is required to bias the annular wall 61 to the braking position.

Only one of the biasing units will be described in this paragraph for the sake of brevity. The radial notch unit 41 is formed in an end surface of the surrounding wall 400 of the mounting seat 40, and has an open radial outer end 411 and an open radial inner end 412, and an integral projecting rod 413 that is disposed in an intermediate portion of the notch unit 41. The limiting ribs 64 are formed integrally with an outer peripheral portion of an end surface of the retainer 60, and are received slidably within a limiting slot 414 (see FIGS. 4 and 6) in an end wall 401′ of the mounting seat 40. The torsion spring 42 has a coiled portion 421 that is sleeved on the projecting rod 413, an outer end 422 that extends from the radial outer end 411 of the notch unit 41 in the mounting seat 40, and an inner end 423 that extends from the radial inner end 412 of the notch unit 41 and that is inserted between the limiting ribs 64 of the retainer 60. The L-shaped tongue 811 projects integrally from an outer peripheral portion of the cover 80, and is disposed adjacent to the radial outer end 411 of the radial notch unit 41 in the mounting seat 40 so as to define a small gap 8112 between the tongue 811 and the mounting seat 40. The gap 8112 is in communication with the radial outer end 411 of the radial notch unit 41. The outer end 422 of the torsion spring 42 is confined within the gap 8112.

Referring to FIG. 8, when the annular wall 61 of the retainer 60 is disposed at the braking position, the rollers 62 are located respectively within the shallow groove portions 721 of the grooves 72 in the outer ring 70. As such, the rollers 62 are clamped between the inner and outer rings 50, 70 so that the inner ring 50 can rotate within the outer ring 70 only in a clockwise direction, thereby preventing unwinding of a fishline from the fishing spool.

Referring to FIG. 9, when it is desired to unwind the fishline from the fishing spool, the annular wall 61 of the retainer 60 is rotated clockwise to the release position such that the rollers 62 are located respectively within the deep groove portions 722 of the grooves 72. As such, the rollers 62 are spaced apart from the inner surface of the outer ring 70 so that the inner ring 50 can rotate within the outer ring 70 in two directions, thereby permitting winding and unwinding of the fishline.

When the annular wall 61 of the retainer 60 is disposed at the release position shown in FIG. 9, the outer and inner ends 422, 423 of the torsion spring 42 are pushed toward each other so as to create a restoration force for biasing the annular wall 61 of the retainer 60 to the braking position shown in FIG. 8.

With this invention thus explained, it is apparent that numerous modifications and variations can be made without departing from the scope and spirit of this invention. It is therefore intended that this invention be limited only as indicated by the appended claims.

I claim:

1. A one-way clutch for a fishing spool, the fishing spool being mounted on a fishing rod and having a center of gravity, a rod-connecting member that is connected fixedly to the fishing rod, a driving shaft that is journalled on the rod-connecting member, and a control rod that is journalled on the rod-connecting member and that is parallel to the driving shaft, said one-way clutch comprising:
a hollow cylindrical mounting seat adapted to be mounted fixedly on the rod-connecting member and to be disposed around the driving shaft;
an inner ring adapted to be disposed around the driving shaft so as to rotate synchronously therewith, said inner ring having an outer surface;
an outer ring mounted fixedly within said mounting seat and disposed around said inner ring, said outer ring having an inner surface, which is formed with a plurality of grooves that are arranged along a circumferential direction of said outer ring, each of said grooves having a shallow groove portion and a deep groove portion that is deeper than said shallow groove portion;
a tubular retainer disposed within said outer ring and around said inner ring, and including an annular wall which is formed with a plurality of roller-confining spaces that are arranged along a circumferential direction of said annular wall, and a push lever that is connected fixedly to said annular wall and that is adapted to be connected to the control rod so as to rotate said annular wall between a braking position and a release position when the control rod is operated;
a plurality of rollers received rotatably within said roller-confining spaces and disposed adjacent to both said inner surface of said outer ring and said outer surface of said inner ring, said rollers being located respectively within said shallow groove portions of said grooves in said outer ring when said annular wall of said retainer is disposed at said braking position so as to permit unidirectional rotation of said inner ring within said outer ring, said rollers being located respectively within said deep groove portions of said grooves when said annular wall is disposed at said release position so as to permit bi-directional rotation of said inner ring within said outer ring;
a cover connected fixedly to an end of said mounting seat and adapted to be disposed around the driving shaft so as to confine said inner ring, said outer ring, said retainer, and said rollers within said mounting seat; and
a bearing adapted to be disposed between said cover and the driving shaft so as to permit rotation of the driving shaft relative to said cover.

2. The one-way clutch as claimed in claim 1, wherein said bearing is adapted to be disposed adjacent to the center of gravity of the fishing spool.

3. The one-way clutch as claimed in claim 1, wherein each of said roller-confining spaces is shaped as an opening that is formed through said annular wall of said retainer.

4. The one-way clutch as claimed in claim 1, further comprising a torsion spring for biasing said annular wall of said retainer to said braking position, said mounting seat including a surrounding wall, which is disposed around said outer ring and which is formed with a radial notch unit that has an open radial outer end and an open radial inner end, and an integral projecting rod that is disposed in an intermediate portion of said notch unit, said retainer having an end surface, which is formed with two radially extending limiting ribs at an outer peripheral portion, said torsion spring having a coiled portion that is sleeved on said projecting rod, an outer end that extends from said radial outer end of said notch unit in said mounting seat, and an inner end that extends from said radial inner end of said notch unit and that is inserted between said limiting ribs of said retainer, said cover including an integral L-shaped tongue that projects from an outer peripheral portion thereof and that is disposed adjacent to said radial outer end of said notch unit in said mounting seat so as to define a gap between said tongue and said mounting seat, said gap being in communication with said radial outer end of said radial notch unit, said outer end of said torsion spring being confined within said gap, said inner and outer ends of said torsion spring being pushed toward each other when said annular wall of said retainer is disposed at said release position so as to create a restoration force for biasing said annular wall of said retainer to said braking position.
